(19) United States
(12) Patent Application Publication
(10) Pub. No.: US 2007/0209754 A1
(43) Pub. Date: Sep. 13, 2007

(54) Nli apparatus of forming gummed member and method of binding document by using same

(76) Inventor: Chun Fu Fu, Fongyuan City (TW)

Correspondence Address: PRO-TECHTOR INTERNATIONAL SERVICES, 20775 NORADA CT., SARATOGA, CA, 95070, US

(21) Appl. No.: 11/371,879

(22) Filed: Mar. 8, 2006

(51) Int. Cl. B32B 37/12; B32B 38/04; B32B 37/26

(52) U.S. Cl. 156/226; 156/249; 156/256; 156/516; 156/529; 156/547; 156/578

(57) ABSTRACT

An apparatus of manufacturing a gummed member includes a supply spool, a support for conveying a continuous sheet of base member from the supply spool, a funnel for depositing adhesive material on the continuous sheet of base member to form a continuous layer-thereon, cooling means, and means for cutting the continuous sheet of base member into base members having a releasable sheet formed thereon. A method of binding papers of a document includes cutting a unit out of a base member formed thereon with a releasable sheet having a gummed member, removing the gummed member, adhering the gummed member to a spine of a hard cover, folding a cover to initially position papers therein, upright holding the cover and inserting same into a binding device for heating the gummed member to bind the papers in the cover, and cooling.

### BACKGROUND OF THE INVENTION

1. Field of Invention

The present invention relates to document binding and more particularly to an apparatus of forming a gummed member and a method of binding papers of a document by means of the gummed member.

2. Related Art

It is typical to keep important papers (e.g., invoices, receipts, or the like) of a company as records for future reference. However, it is also known that loose papers of a folder tend to be lost. Binders also have similar drawbacks. Thus, the need for improvement of binding papers still exists.

### SUMMARY OF THE INVENTION

It is therefore an object of the present invention to provide an apparatus of manufacturing a gummed member for document binding, comprising a supply spool with a continuous sheet of base member wound therearound; a support having rollers for guiding the continuous sheet of base member from the supply spool to move along its top; a funnel disposed above the support for depositing adhesive material on the continuous sheet of base member to form a continuous layer of uniform thickness thereon; means disposed at a rear of the support for cooling the continuous sheet of base member and the continuous layer; and means for cutting the continuous sheet of base member and the continuous layer into a plurality of base members having a releasable sheet formed thereon; wherein the releasable sheet is adapted to remove from the base member to expose its gummed member.

It is another object of the present invention to provide a method of binding papers of a document, comprising cutting a rectangular unit out of a base member formed thereon with a releasable sheet having a gummed member; removing the gummed member from the unit by tearing; adhering the gummed member to a spine of a hard cover; placing a plurality of papers on either half portion of an inner surface of the cover; folding the cover to initially position the papers with one sides of the papers engaged with the gummed member; upright holding the cover and inserting same into a slot of a binding device to rest upon a heating element on a bottom of the slot; activating the heating element to melt the gummed member for binding the papers in the cover; and cooling for a predetermined period of time to produce the document.

In one aspect of the present invention the base member is formed of a heat-resistant, transparent plastic material.

The above and other objects, features and advantages of the present invention will become apparent from the following detailed description taken with the accompanying drawings.

### BRIEF DESCRIPTION OF THE DRAWINGS

FIG. 1 is a perspective view of a base member for binding papers of a document according to the invention;

FIG. 2 is a view similar to FIG. 1 where a sheet is being torn away from the base member;

FIG. 3 is a perspective view of a rectangular hard cover for the document;

FIG. 4 is a perspective view of another base member having one end being cut by a pair of scissors;

FIG. 5 is a perspective view of the cut piece in FIG. 4;

FIG. 6 is a perspective view of the cover with the gummed member adhered to its central portion;

FIG. 7 is a side view of the folded cover in FIG. 6 with papers being initially positioned therein;

FIG. 8 is a side view schematically depicting the cover and papers in FIG. 7 being placed in a slot of a binding device prior to heating for binding as a document;

FIG. 9 is a side view of an enlarged spine portion of the document to be bound in FIG. 7;

FIG. 10 is a side view schematically depicting an apparatus of adhering sheets to base members in a manufacturing process;

FIG. 11 is a perspective view of the stacked base members produced by the apparatus; and

FIG. 12 is a top view of the base member with the sheet removed for showing squares printed thereon.

### DETAILED DESCRIPTION OF THE INVENTION

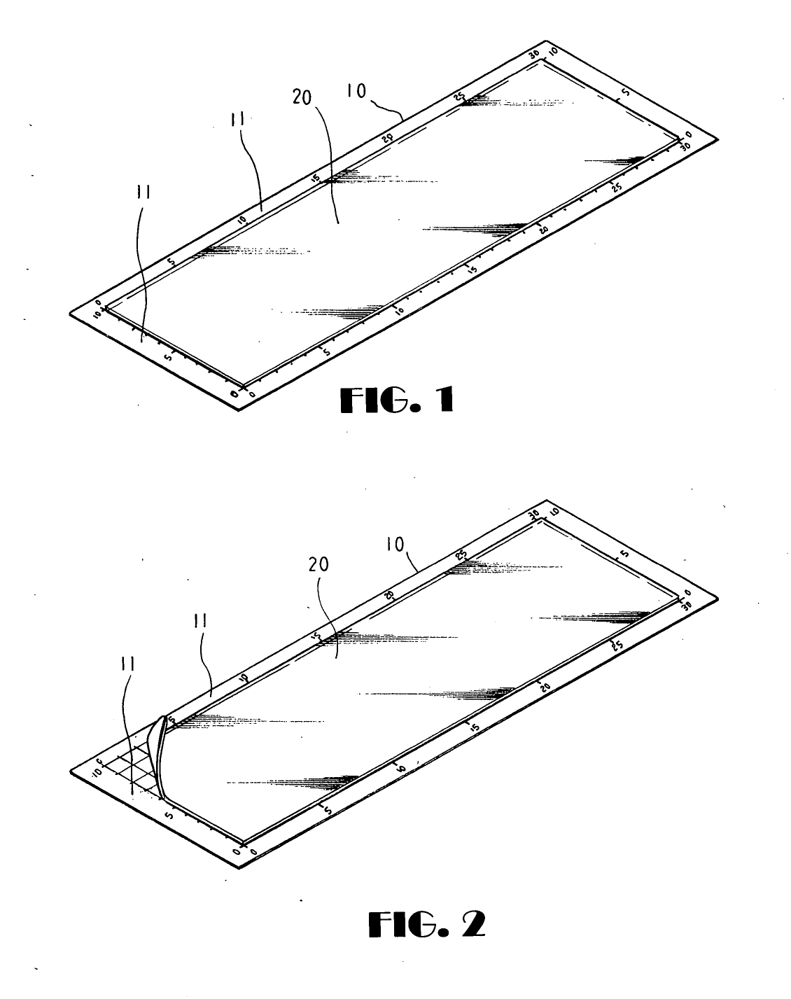

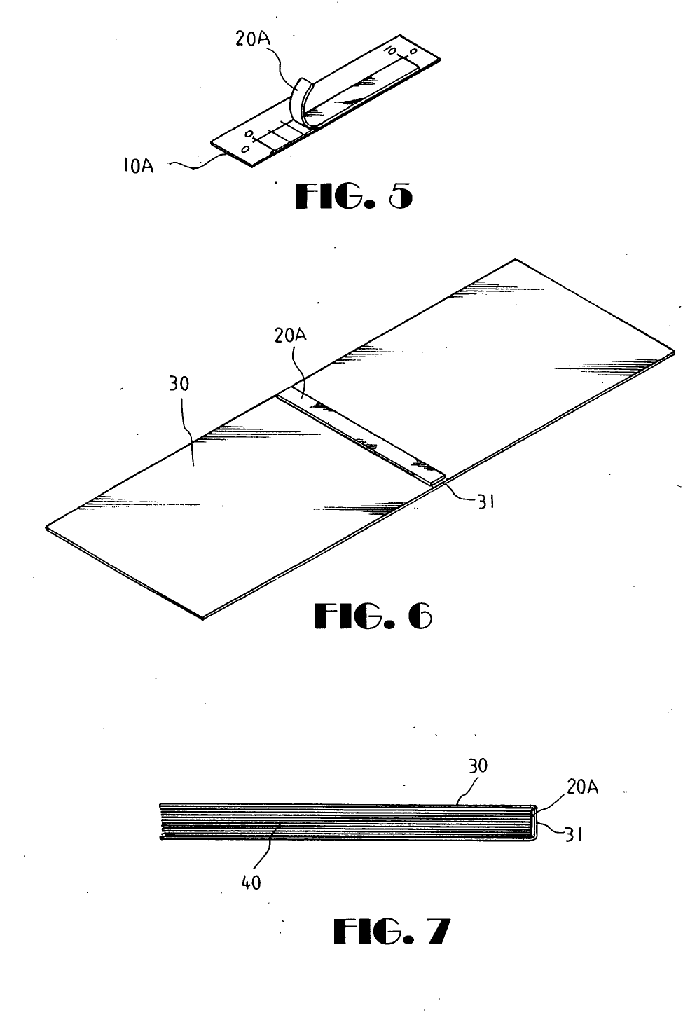

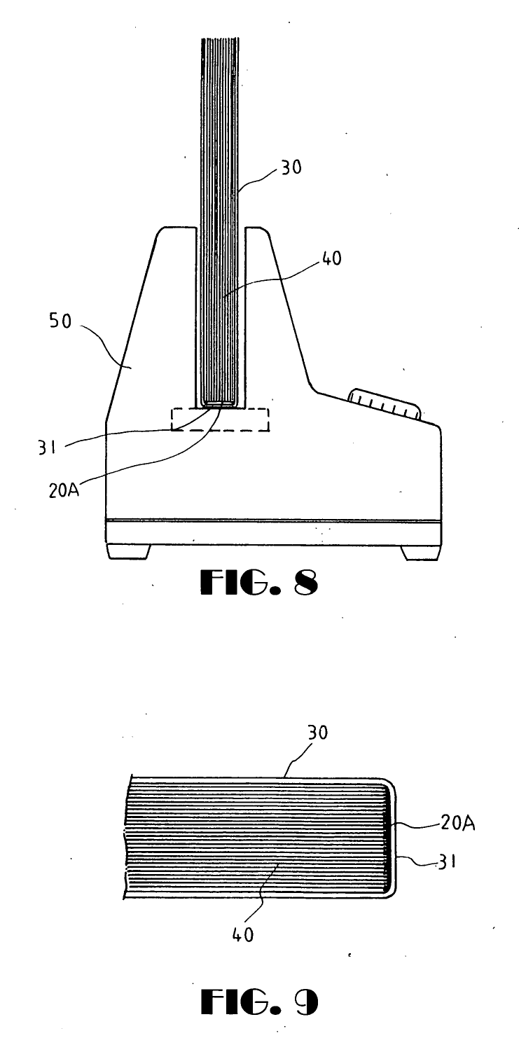

Referring to FIGS. 1 to 12, a preferred embodiment of the invention is shown. As shown in FIGS. 1 and 2, a rectangular base member 10 comprises a rectangular, releasable sheet 20 having a size slightly smaller than the base member 10. A closed margin 11 is thus formed around the sheet 20 and between an outer edge of the base member 10 and that of the sheet 20. Markings are formed on each of sides and ends of the margin 11.

As shown in FIG. 3, a rectangular hard cover 30, in its extended state, comprises a spine 31 on its central portion for dividing the cover 30 into two equal portions.

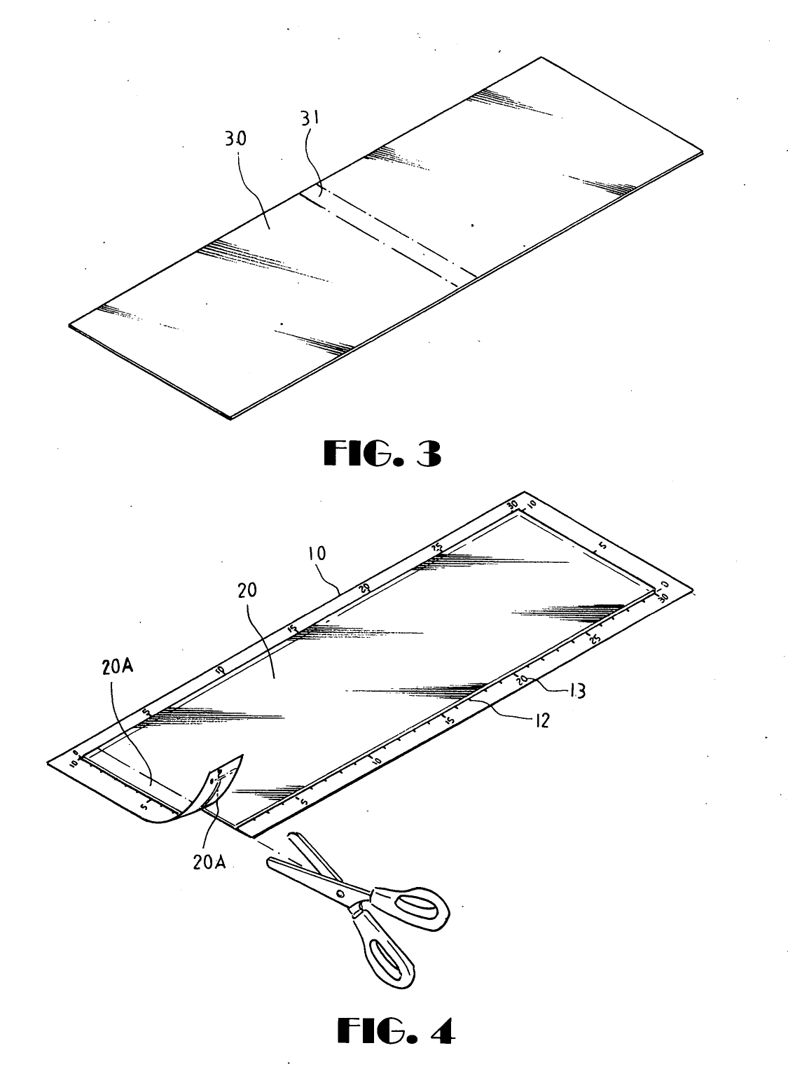

As shown in FIGS. 4 to 9, a simple process of binding a document as done in an office is illustrated. First, for example, a pair of scissors is employed to cut a rectangular member 10A including a rectangular gummed member 20A out of the base member 10. Next, the person may remove the gummed member 20A from the member 10A by tearing. Adhere a bottom of the gummed member 20A to the spine 31. Next, fold the cover 30 to initially position a suitable number of papers 40 therein in which one sides of the papers 40 are engaged with the gummed member 20A. Next, hold the cover 30 in an upright position prior to inserting a lower portion thereof into a U-shaped slot of a binding device 50 to rest on a heating element (indicated by dashed lines) on the bottom of the slot. Next, activate the heating element to melt the gummed member 20A for binding the papers 40 in the cover 30. Next, wait for a period of predetermined cooling time to produce a bound document. Finally, remove the bound document from the binding device 50.

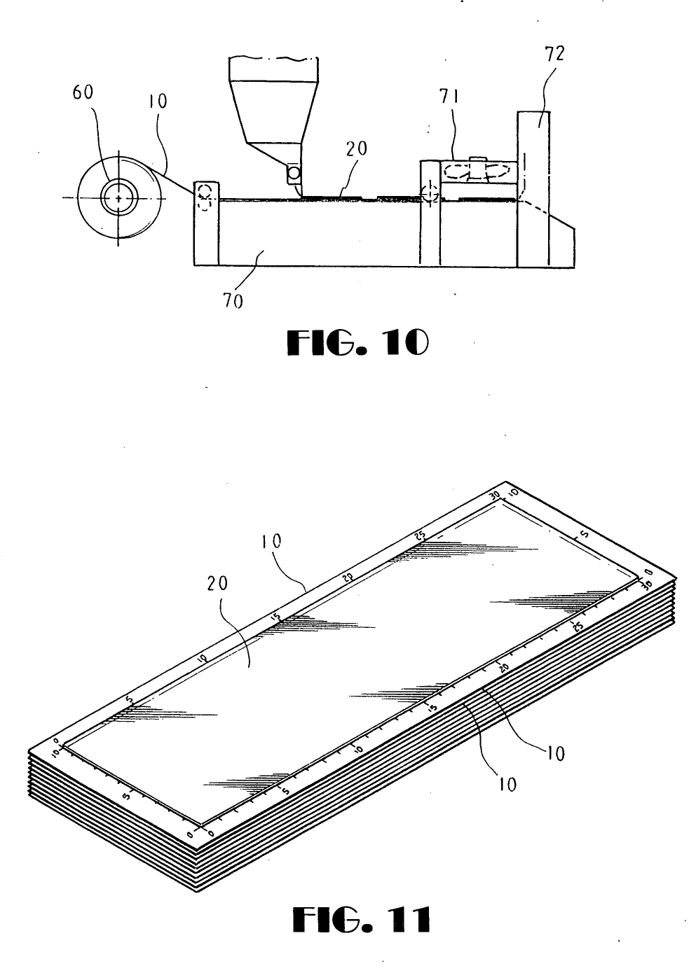

As shown in FIGS. 10 and 11, an apparatus comprises a supply spool 60 with a continuous sheet of base member 10 wound therearound, a support 70 having rollers for guiding the continuous sheet of base member 10 from the supply spool 60 to move along its top, a funnel for depositing adhesive material on the continuous sheet of base member 10 to form a continuous sheet 20 of uniform thickness thereon, a cooling unit (e.g., fan) 71 for lowering temperature of the continuous sheet of base member 10 and the continuous sheet 20 to a predetermined temperature, and a cutting unit 72 for cutting the continuous sheet of base member 10 and the continuous sheet 20 into a plurality of base members 10 having the sheet 20 formed thereon. The base members 10 are stacked as a pile. The base members 10 are not susceptible to being loosened since the sheet 20 has a certain degree of adhesiveness.

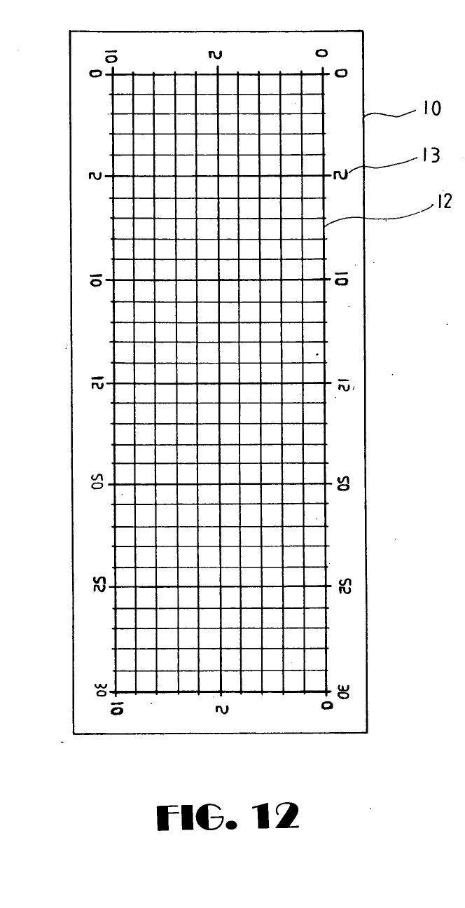

In FIG. 12, the base member 10 is shown with the sheet 20 removed so as to show squares 12 printed thereon. It is possible of causing the markings 13 to become apparent when taking the squares 12 as references.

Note that the base member 10 is formed of a heat-resistant, transparent plastic material with a small thickness.

While the invention herein disclosed has been described by means of specific embodiments, numerous modifications and variations could be made thereto by those skilled in the art without departing from the scope and spirit of the invention set forth in the claims.

1. (canceled)

2. (canceled)

3. A method of binding papers of a document, comprising:
cutting a rectangular unit out of a base member formed thereon with a releasable sheet having a gummed member;
removing the gummed member from the unit by tearing;
adhering the gummed member to a spine of a hard cover;
placing a plurality of papers on either half portion of an inner surface of the cover;
folding the cover to initially position the papers with one sides of the papers engaged with the gummed member;
upright holding the cover and inserting same into a slot of a binding device to rest upon a heating element on a bottom of the slot;
activating the heating element to melt the gummed member for binding the papers in the cover; and
cooling for a predetermined period of time to produce the document.

4. The method of claim 1, wherein the base member is formed of a heat-resistant, transparent plastic material.

5. An adhesive binder-sheet for document binding, comprising:
a base member being made of a heat resistant, substantially transparent plastic material, with a markings pattern printed thereon, and having at least one release surface;
an adhesive layer releasably disposed on a central portion of said base member; and
an enclosing margin peripherally surrounding the adhesive layer, and revealing at least a portion of said markings pattern;
wherein an adhesive member of a selected size cut from the adhesive binder sheet is adapted to be adhesively transferred to a spine of a document cover, and the base member releasably removed, in preparation for binding a document by heating the adhesive member.

6. The adhesive binder sheet for document binding of claim 5, wherein the base member is formed of a heat-resistant, substantially transparent plastic material.

7. An apparatus of manufacturing the adhesive binder sheet for document binding of claim 5, comprising:
a dispensing supply spool having a continuous base member wound therearound, said base member having a repeating markings pattern printed thereon, and having at least one release surface;
a transport support having rollers for guiding the continuous sheet of base member to move from the supply spool;
an applicator disposed adjacent to the transport support for depositing adhesive material on the continuous base member to form a sequence of discrete releasable adhesive layers aligned to the repeat of the markings pattern thereon;
a cooling unit for cooling the continuous base member and the releasable adhesive layers; and
a cutting unit for cutting the continuous base member with the releasable adhesive layer into a plurality of sheet-form base members, each having a marking pattern and a releasable adhesive member formed thereon with an enclosing margin peripherally surrounding the releasable adhesive member;
wherein an adhesive member of a selected size, cut from the adhesive binder sheet, is adapted to be adhesively transferred to a spine of a document cover, and the base member releasably removed, in preparation for binding a document by heating the adhesive member.

8. The apparatus of manufacturing an adhesive binder sheet for document binding of claim 7, wherein the base member is formed of a heat-resistant, transparent plastic material.
